(19) United States
(12) Patent Application Publication
(10) Pub. No.: US 2012/0216896 A1
(43) Pub. Date: Aug. 30, 2012

(54) SERVO VALVE

(75) Inventors: Toshikazu Hayashi, Nagasaki-shi (JP); Atsushi Yuge, Nagasaki-shi (JP); Michiya Uchida, Shimonoseki-shi (JP); Makoto Kuga, Shimonoseki-shi (JP); Minobu Tsurutani, Shimonoseki-shi (JP); Taito Ogushi, Shimonoseki-shi (JP)

(73) Assignee: MITSUBISHI HEAVY INDUSTRIES, LTD., MINATO-KU, TOKYO (JP)

(21) Appl. No.: 13/057,615

(22) PCT Filed: May 29, 2009
(86) PCT No.: PCT/JP09/59859

§ 371 Date: Feb. 4, 2011

(30) Foreign Application Priority Data
Aug. 8, 2008 (JP) 2008-206370
Apr. 23, 2009 (JP) 2009-105444

(51) Int. Cl. F15B 13/043

(52) U.S. Cl. 137/625.64; 137/625.69; 251/30.01

(57) ABSTRACT

It is an object to provide a servo valve that can be manufactured at low cost by simplifying adjustment of the relative position between a nozzle and a flapper and simplifying the configuration of a valve-element driving circuit. Provided is a servo valve (1) including a spool (5) mounted so as to be movable back and forth; a first chamber (7) and a second chamber (9) that mutually push the spool (5) in opposite directions by means of fluid pressure; and a spool driving circuit (3) that supplies oil to the first chamber (7) and the second chamber (9) and that adjusts the pressure of supplied oil to move the spool (5) back and forth, wherein the spool driving circuit (3) maintains the fluid pressure of the first chamber (7) at a substantially constant level and includes, at an oil outlet of the second chamber (9), a nozzle flapper mechanism (27) that adjusts the fluid pressure of the second chamber (9).

### TECHNICAL FIELD

The present invention relates to a servo valve.

### BACKGROUND ART

Servo valves are widely used for controlling driving of a hydraulic or pneumatic actuator.

Some servo valves use a spool that is driven back and forth as a valve element. For such servo valves, a nozzle flapper mechanism, as disclosed in Patent Literature 1, for example, is proposed as a mechanism for driving the spool.

This is configured such that a variable orifice is formed of a pair of nozzles and a flapper disposed between the nozzles, deriving back pressures of the nozzles, which change depending on the position of the flapper, and the spool is driven by the pressure difference between the derived back pressures.

A mechanism that uses an electromagnetic coil for this displacement of the flapper is used; however, a mechanism that uses a compact, high-speed, high-generative-power piezoelectric element (a layered piezoelectric element or a bimorph piezoelectric element) has been proposed because size reduction and high performance of servo valves have been required recently.

### CITATION LIST

### Patent Literature

Japanese Unexamined Patent Application, Publication No. 2001-82411

### SUMMARY OF INVENTION

### Technical Problem

With the configuration in which a variable orifice is formed of a pair of nozzles and a flapper disposed between the nozzles, the flapper needs to be mounted in an orientation such that it opposes the nozzles or in an orientation in which a uniform influence is exerted thereon in order to improve the operating accuracy of the spool. This therefore poses the problem of difficulty in adjusting the position of the flapper during mounting.

Furthermore, since it is necessary to accurately move the flapper to both sides, for example, in the case of layered piezoelectric elements, large layered piezoelectric elements should be provided at both sides of the flapper. Therefore, this increases the size of the servo valve and makes the control of a control system for moving the flapper difficult, thus making it difficult to put it to practical use.

Furthermore, in the case where a piezoelectric element is used in adjusting the position of the flapper, if an electrode and a body (valve main body) make contact, an excess current flows, thus hindering driving of the flapper, and the occurrence of such a situation must be assuredly prevented.

In consideration of such circumstances, an object of the present invention is to provide a servo valve that can be manufactured at low cost by simplifying adjustment of the relative position between a nozzle and a flapper and simplifying the configuration of a valve-element driving circuit.

### Solution to Problem

The present invention adopts the following solutions to solve the problems described above.

Specifically, one aspect of the present invention is a servo valve including a valve element mounted so as to be movable back and forth; a first pushing portion and a second pushing portion that mutually push the valve element in opposite directions by means of fluid pressure; and a valve-element driving circuit that supplies fluid to the first pushing portion and the second pushing portion and adjusts the pressure of the supplied fluid to move the valve element back and forth, wherein the valve-element driving circuit maintains the fluid pressure of the first pushing portion at a substantially constant level and includes a nozzle flapper mechanism, at a fluid outlet of the second pushing portion, that adjusts the fluid pressure of the second pushing portion.

Since the valve element mounted so as to be movable back and forth is mutually pushed in opposite directions by means of the fluid pressures of the first pushing portion and the second pushing portion, the valve is moved back and forth due to the difference in fluid pressure between the first pushing portion and the second pushing portion. That is, the valve element moves in the direction in which the fluid pressure of a pushing portion having a higher fluid pressure of the fluid pressures of the first pushing portion and the second pushing portion acts.

According to this aspect, since the first pushing portion fluid pressure is maintained at a substantially constant level, the valve element moves back and forth by adjusting the fluid pressure of the second pushing portion to a higher or lower level than the fluid pressure of the first pushing portion.

Since the nozzle flapper mechanism is provided at the fluid outlet of the second pushing portion, the pressure of the fluid in the second pushing portion can be adjusted by adjusting the distance between the end of the nozzle provided at the fluid outlet and the flapper. When the pressure of the fluid in the second pushing portion fluid pressure can be adjusted, the fluid pressure in the second pushing portion can be adjusted, so that the fluid pressure of the second pushing portion can be made higher or lower than the constant fluid pressure of the first pushing portion.

Since the nozzle flapper mechanism is disposed only at the outlet of the second pushing portion, that is, the flapper is opposed to just one nozzle, as described above, the positional adjustment of the flapper to the nozzle can be performed easily. This allows accurate placement of the flapper in a short time.

Furthermore, since the circuit configuration of the valve-element driving circuit can be simplified, the machining costs of the valve main body can be reduced.

This allows the servo valve to be manufactured at low cost.

In addition, to maintain the first pushing portion at a substantially constant pressure, the pressure of the fluid should be maintained substantially constant by, for example, providing a orifice in a fluid passage to the first pushing portion.

In the above aspect, in the valve element, a first pressure-receiving area where the fluid in the first pushing portion acts on the valve element and a second pressure-receiving area where the fluid in the second pushing portion acts on the valve element may be set to substantially the same area.

The fluid force of the first pushing portion is obtained by multiplying the first pressure-receiving area by the pressure of fluid in the first pushing portion. The fluid force of the second pushing portion is obtained by multiplying the second pressure-receiving area by the pressure of the fluid in the second pushing portion.

Since the first pressure-receiving area and the second pressure-receiving area are set to substantially the same area, the relative levels of the fluid pressure of the first pushing portion and the second pushing portion are determined by the pressures of the individual fluids.

The pressure of the liquid in the first pushing portion is set to the level of an intermediate pressure in an intermediate portion in the pressure range of the fluid in the second pushing portion adjusted by the nozzle flapper mechanism. Since the pressure of the fluid in the second pushing portion, in other words, the fluid pressure of the second pushing portion, can be set higher or lower than the pressure of the fluid in the first pushing portion that is maintained constant, in other words, the fluid pressure of the first pushing portion, the valve element can be moved back and forth.

In addition, in view of ease of adjustment, it is desirable that the pressure of the fluid in the first pushing portion be set so as to be equal to a substantially intermediate level between that of the pressure of the fluid in the second pushing portion in a state in which no voltage is applied to the nozzle flapper mechanism and that of the pressure of the fluid in the second pushing portion in a state in which the maximum voltage is applied to the nozzle flapper mechanism.

In the above aspect, in the valve element, a first pressure-receiving area where the fluid in the first pushing portion acts on the valve element and a second pressure- receiving area where the fluid in the second pushing portion acts on the valve element may be set to substantially different areas.

The fluid force of the first pushing portion is obtained by multiplying the first pressure-receiving area by the pressure of fluid in the first pushing portion. The fluid force of the second pushing portion is obtained by multiplying the second pressure-receiving area by the pressure of the fluid in the second pushing portion.

The pressure of the fluid in the first pushing portion is set to a level obtained by multiplying an intermediate pressure in an intermediate portion in the pressure range of the fluid in the second pushing portion adjusted by the nozzle flapper mechanism by the second pressure-receiving area/first pressure-receiving area. When the pressure of the fluid in the second pushing portion is set higher than the intermediate pressure, the fluid pressure of the second pushing portion becomes higher than the fluid pressure of the first pushing portion, so that the valve element is moved in the direction of the first pushing portion. When the pressure of the fluid in the second pushing portion is set lower than the intermediate pressure, the fluid pressure of the second pushing portion becomes lower than the fluid pressure of the first pushing portion, so that the valve element is moved in the direction of the second pushing portion.

The pressure of the fluid in the first pushing portion is set to a level obtained by multiplying the intermediate pressure of the fluid in the second pushing portion by the second pressure-receiving area/first pressure-receiving area in this way; therefore, for example, in the case where fluid is supplied from the same supply source, setting the intermediate pressure to a level obtained by multiplying the pressure of the supplied fluid by the first pressure-receiving area/second pressure-receiving area allows the supplied fluid and the intermediate pressure to be the same pressure even if the supplied fluid is directly introduced from the supply source to the first pushing portion.

In other words, by setting the intermediate pressure of the fluid to be supplied to the second pushing portion to a level obtained by multiplying the pressure of the supplied fluid by the first pressure-receiving area/second pressure- receiving area, the pressure of the fluid in the first pushing portion can be made the same as the pressure of the supplied fluid, and thus, a member for adjusting the pressure of the fluid supplied to the first pushing portion can be eliminated.

This can further simplify the circuit configuration of the valve-element driving circuit, thereby further reducing the machining costs of the valve main body, thus allowing the servo valve to be manufactured at low cost.

In the above aspect, a flapper of the nozzle flapper mechanism may be driven by a bimorph piezoelectric element.

Since a bimorph piezoelectric element that has a relatively large deformation amount and that can be driven at a low voltage is used, a small nozzle flapper mechanism including a power supply can be configured. Furthermore, the relatively low cost of the bimorph piezoelectric element can reduce further the manufacturing costs of the servo valve

In the above aspect, a flapper of the nozzle flapper mechanism may be driven by a layered piezoelectric element.

Since the distance of the flapper relative to one nozzle is adjusted, only one layered piezoelectric element is needed to move it. This allows a smaller configuration as compared with a mechanism having large layered piezoelectric elements at both sides of the flapper, thus allowing the servo valve to be made more compact. Furthermore, this also allows the control of a control system for moving the flapper to be simplified.

Thus, a practical servo valve can be provided

In the above aspect, a flapper of the nozzle flapper mechanism may be driven by a torque motor.

This allows a servo valve capable of stable adjustment to be configured using a proven torque motor.

### Advantageous Effects of Invention

With the servo valve according to the present invention, since the pressure of the first pushing portion is maintained at a substantially constant level, and a nozzle flapper mechanism that adjusts the pressure of the second pushing portion is provided at a fluid outlet of the second pushing portion, positional adjustment of the flapper relative to the nozzle by the nozzle flapper mechanism can easily be performed. This allows accurate placement of the flapper in a short time.

Furthermore, since the circuit configuration of the valve-element driving circuit can be simplified, the machining costs of the valve main body can be reduced.

This allows the servo valve to be manufactured at low cost.

### BRIEF DESCRIPTION OF DRAWINGS

FIG. 1 is a circuit diagram illustrating a spool driving circuit of a first embodiment of the present invention.

FIG. 2 is a partial sectional view illustrating part of a nozzle flapper mechanism of the first embodiment of the present invention.

FIG. 3 is a cross-sectional view illustrating, in outline, the configuration of a flapper unit of the first embodiment of the present invention.

FIG. 4 is a cross-sectional view illustrating a flapper manufacturing process of the first embodiment of the present invention.

FIG. 5 is a cross-sectional view illustrating a flapper unit manufacturing process of the first embodiment of the present invention.

FIG. 6 is a cross-sectional view illustrating a flapper unit curing process of the first embodiment of the present invention.

FIG. 7 is a circuit diagram illustrating another form of the spool driving circuit of the first embodiment of the present invention.

FIG. 8 is a circuit diagram illustrating yet another form of the spool driving circuit of the first embodiment of the present invention.

FIG. 9 is a circuit diagram illustrating a spool driving circuit of a second embodiment of the present invention.

FIG. 10 is a partial sectional view illustrating part of a nozzle flapper mechanism of the second embodiment of the present invention.

FIG. 11 is a cross-sectional view taken along line X-X in FIG. 9.

FIG. 12 is a cross-sectional view taken along line Y-Y in FIG. 9.

FIG. 13 is a circuit diagram illustrating another form of the spool driving circuit of the second embodiment of the present invention.

FIG. 14 is a cross-sectional view taken along line Y-Y in FIG. 13.

### DESCRIPTION OF EMBODIMENTS

Embodiments of the present invention will be described hereinbelow with reference to the drawings.

### First Embodiment

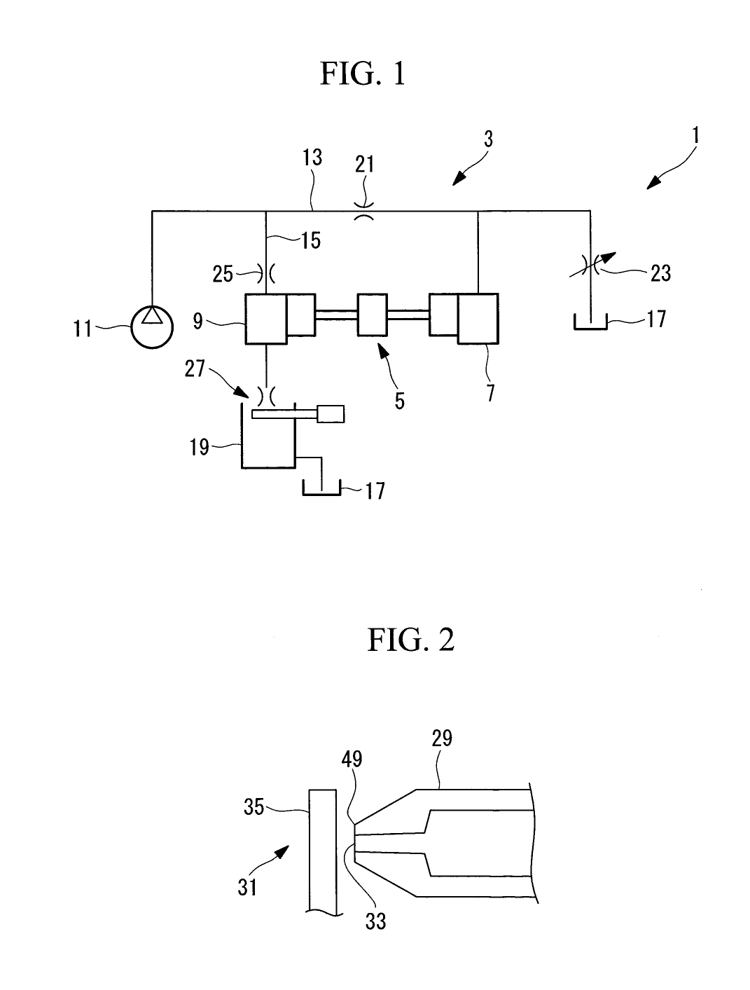

A servo valve 1 for controlling driving of a hydraulic actuator according to a first embodiment of the present invention will be described hereinbelow using FIGS. 1 to 6.

FIG. 1 is a circuit diagram illustrating a spool driving circuit (valve-element driving circuit) 3 of the servo valve 1. FIG. 2 is a partial sectional view illustrating part of a nozzle flapper mechanism.

The servo valve 1 is configured such that a spool (valve element) 5 that controls driving of a hydraulic actuator (not shown) can be moved in the axial direction.

The spool 5 has the function of switching a working-oil supply direction to the hydraulic actuator depending on the position in the axial direction.

The axial position of the spool 5 can be detected by a position detector (not shown).

A first chamber (first pushing portion) 7 and a second chamber (second pushing portion) 9, which are spaces that open at the spool 5 side, are provided at both ends of the spool 5.

The spool driving circuit 3 is provided with a pump 11 that supplies oil (fluid). The oil from the pump 11 is divided into a first passage 13 and a second passage 15. The oil that passes through the first passage 13 is supplied to the first chamber 7 and is also returned to a tank 17.

The oil that passes through the second passage 15 is supplied to the second chamber 9 and is thereafter discharged to a pipe 19. The oil discharged to the pipe 19 is returned to a tank 17.

The pressure receiving areas of the spool 5 on which the oil in the first chamber 7 and the second chamber 9 acts are set to substantially equal areas. The difference between fluid pressures that the oil in the first chamber 7 and the second chamber 9 exerts on the spool 5 is in proportion to a difference in oil pressure.

The first passage 13 is provided with a first orifice 21 upstream of the first chamber 7 and a pressure regulating orifice 23 downstream of the first chamber 7.

An example of the first orifice 21 is an orifice, which specifies the pressure of oil supplied to the first chamber 7. The pressure P1 of the oil supplied to the first chamber 7 is set, for example, to substantially half of the pressure Ps of the oil discharged from the pump 11.

The opening area of the pressure regulating orifice 23 can be changed so as to adjust the pressure of the oil in the first chamber 7.

The second passage 15 is provided with a second orifice 25 upstream of the second chamber 9 and a nozzle flapper mechanism 27 at the downstream end.

An example of the second orifice 25 is an orifice, whose opening area is equal to that of the first orifice 21. The nozzle flapper mechanism 27 is provided with a nozzle 29 mounted at the downstream end of the second passage 15 and a flapper unit 31 opposed to an opening 33 of the nozzle 29 and constituting a orifice. The nozzle 29 is a orifice mechanism in which the opening area of the opening 33, at an origin (in a state in which no voltage is applied to the flapper 35), is equal to the opening area of the pressure regulating orifice 23, so that the pressure of the oil in the second chamber 9 is equal to the pressure of the oil in the first chamber 7.

When the flapper 35 moves from the origin to come away from the nozzle 29 to increase the area of the opening 33, the pressure of the oil in the second chamber 9 becomes lower than the pressure of the oil in the first chamber 7. In contrast, when the flapper 35 moves from the origin to come close to the nozzle 29 to decrease the area of the opening 33, the pressure of the oil in the second chamber 9 becomes higher than the pressure of the oil in the first chamber 7.

Accordingly, the pressure of the oil in the second chamber 9 at the origin is an intermediate pressure located at the intermediate portion of a range in which the pressure can be adjusted by the nozzle flapper mechanism 27.

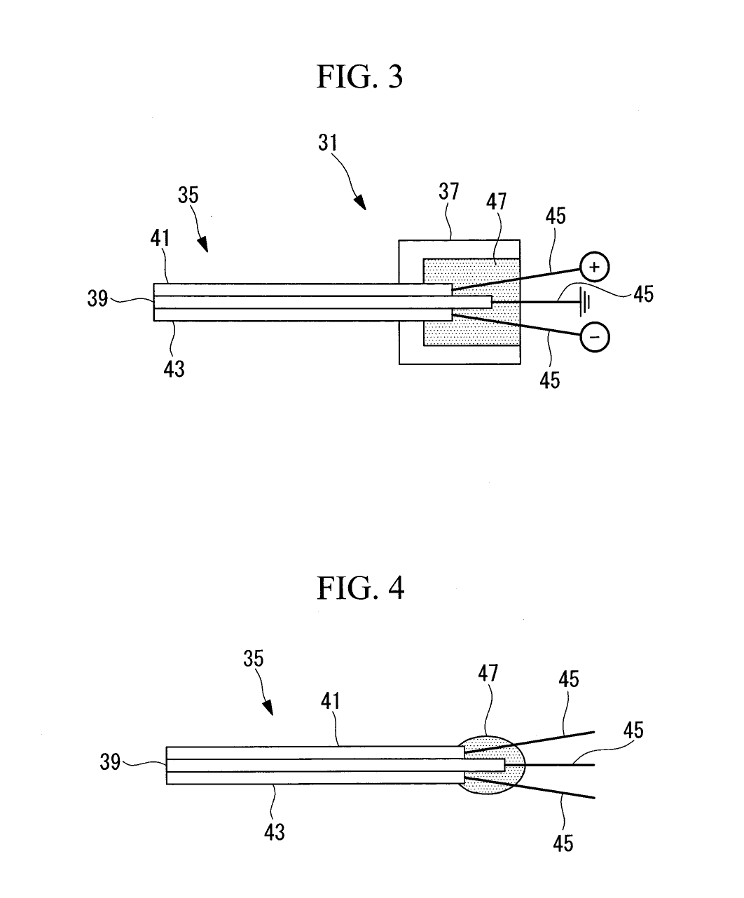

FIG. 3 is a cross-sectional view illustrating, in outline, the configuration of the flapper unit 31.

The flapper unit 31 is provided with a flapper 35 and a case 37 that holds the flapper 35. The case 37 is made of metal and has a hollow, rectangular parallelepiped shape one face of which is open.

The flapper 35 has a configuration in which two plate-like piezoelectric elements 41 and 43 are bonded to both sides of a metal plate 39, that is, a bimorph piezoelectric element.

Electrical wires 45 are attached to the ends of the metal plate 39 and the piezoelectric elements 41 and 43. The metal plate 39 is grounded, the piezoelectric element 41 carries a positive voltage, and the piezoelectric element 43 carries a negative voltage.

One end of the flapper 35 is inserted into the inner space of the case 37 and is fixed to the case 37 together with the electrical wires 45 by an adhesive 47. The adhesive 47 is a resin having electrical insulating properties, for example, a molding agent, such as epoxy resin.

The lateral area of a cylinder formed by the flapper 35 and the distal outer peripheral end 49 of the nozzle 29 determines the orifice level of the nozzle flapper mechanism 27. A position at which the lateral area is equal to the opening area of the opening 33 is a limit position at which the nozzle flapper mechanism 27 can offer the orifice function. That is, when the flapper 35 comes away from the nozzle 29 relative to this position, the throttling effect becomes smaller than the throttling effect of the nozzle 29, and thus, the nozzle flapper mechanism 27 provides no orifice function.

The flapper 35 is disposed at a midpoint position between this limit position and a position at which the flapper 35 and the nozzle 29 are in contact and, with that position as the center, is configured to be displaced between the limit position and the position at which the flapper 35 and the nozzle 29 are in contact.

A method for assembling this flapper unit 31 will be described hereinbelow with reference to FIGS. 4 to 6.

First, the plate-like piezoelectric elements 41 and 43 are bonded to both sides of the metal plate 39.

Next, the electrical wires 45 are joined to the ends of the metal plate 39 and the piezoelectric elements 41 and 43 by, for example, soldering.

Next, as shown in FIG. 4, the peripheral portion of the contact points between the metal plate 39 and the piezoelectric elements 41 and 43 and the electrical wires 45 is fixed by the adhesive 47 to form the flapper 35.

At that time, since the amount of the adhesive 47 is small, problems such as deformation of the electrical wires 45 do not occur. That is, deformation whereby the contact points come off or the electrical wires 45 come into contact with the case does not occur.

After the adhesive 47 hardens, the insulation resistance of the electric circuit is measured to check that it is properly insulated.

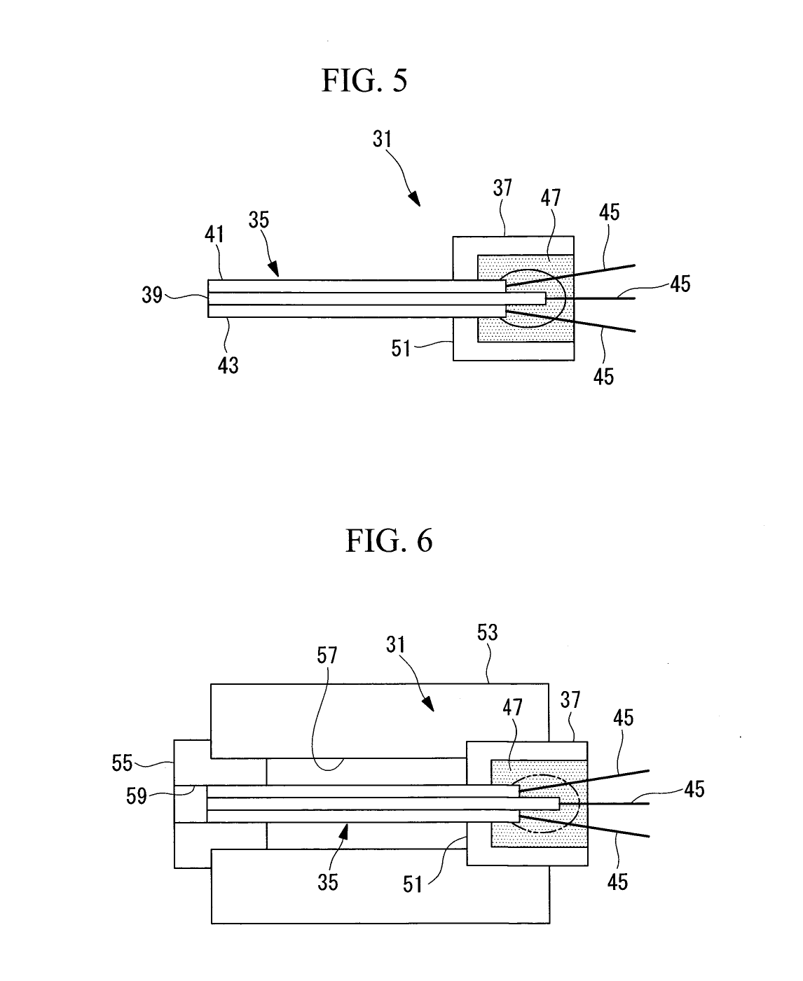

Next, as shown in FIG. 5, this flapper 35 is mounted at a predetermined position of the case 37, and the adhesive 47 is injected into the inner space of the case 37.

Injection of the adhesive 47 causes a large force to act on the flapper 35; however, since the contact points between the metal plate 39 and the piezoelectric elements 41 and 43 and the electrical wires 45 is protected by the adhesive 47, which is hardened in advance, they do not come off. Furthermore, since the movable portions of the electrical wires 45 are not long, the electrical wires 45 are not greatly deformed so as to come into contact with the case 37.

The added adhesive 47 is cured to be hardened in the state in FIG. 5.

At this time, it is important that the end face 51 of the case 37 and the surface of the flapper 35 intersect at right angles; therefore, the curing may be performed by disposing the flapper unit 31 in a first jig 53 and a second jig 55 that maintain the intersecting state, as shown in FIG. 6.

The first jig 53 has a through-hole 57 having a rectangular cross section. The through-hole 57 has an enlarged portion at one end so that the end face 51 of the case 37 intersects the through-hole at right angles.

The second jig 55 is formed so that one end thereof can be inserted into the through-hole 57. The second jig 55 is provided with a through-hole 59 into which the flapper 35 is inserted.

The vertical center positions of the through-hole 57 and the through-hole 59 are aligned.

The case 37 is inserted into the through-hole 57 from the flapper 35 side and is fitted into the enlarged portion. Next, the second jig 55 is inserted from the opposite side of the through-hole 57, and the end of the flapper 35 is inserted into the through-hole 59. Thus, the end face 51 of the case 37 and the surface of the flapper 35 intersect at right angles.

When cured in this state, the adhesive 47 is hardened, so that the flapper 35 is fixed to the case 37 in the form in which the end face 51 of the case 37 and the surface of the flapper 35 intersect at right angles.

The adhesive 47 may be injected while the flapper unit 31 is retained by the first jig 53 and the second jig 55.

The operation of the thus-configured spool driving circuit 3 will now be described.

When the pump 11 is driven to supply oil, the supplied oil is divided and flows into the first passage 13 and the second passage 15. The oil flowing into the first passage 13 is reduced in pressure by the first orifice 21, flows into the first chamber 7, and is also returned to the tank 17 through the pressure regulating orifice 23.

The oil flowing into the second passage 15 is reduced in pressure by the second orifice 25 and flows into the second chamber 9. The oil is discharged from the second chamber 9 to the pipe 19 through the nozzle flapper mechanism 27 and is returned from the pipe 19 to the tank 17.

At this time, if the flapper 35 is located at the origin, the opening area of the opening 33 is equal to the opening area of the pressure regulating orifice 23; therefore, the pressure of the second chamber 9 becomes the same as the pressure of the first chamber 7, so that the differential pressure between the first chamber 7 and the second chamber 9 becomes 0. In the state of the differential pressure of 0, the spool 5 is in a halted state.

When a + (−) voltage is applied to the flapper 35, the flapper 35 is displaced to the nozzle 29 side, so that the lateral area of the cylinder formed by the flapper 35 and the distal outer peripheral end 49 of the nozzle 29, that is, the orifice level of the nozzle flapper mechanism 27, becomes smaller than that of the pressure regulating orifice 23.

When the orifice level of the nozzle flapper mechanism 27 becomes lower, the throttling effect of the nozzle flapper mechanism 27 becomes larger than that of the nozzle 29, so that the pressure of the second chamber 9 becomes higher than that of the first chamber 7, which causes a differential pressure between the first chamber 7 and the second chamber 9. This differential pressure moves the spool 5 to the first chamber 7 side.

When a − (+) voltage is applied to the flapper 35, the flapper 35 is displaced in a direction away from the nozzle 29, so that the lateral area of the cylinder formed by the flapper 35 and the distal outer peripheral end 49 of the nozzle 29, that is, the orifice level of the nozzle flapper mechanism 27, becomes larger than that of the pressure regulating orifice 23.

When the orifice level of the nozzle flapper mechanism 27 becomes higher than that of the pressure regulating orifice 23, the pressure of the second chamber 9 becomes lower than that of the first chamber 7, which causes a differential pressure between the first chamber 7 and the second chamber 9. This differential pressure moves the spool 5 to the second chamber 9 side.

Thus, since the pressure of oil supplied to the first chamber 7 is maintained at a substantially constant level, the spool 5 moves back and forth by adjusting the pressure of the second chamber 9 to a higher or lower level than the pressure of the first chamber 7 using the nozzle flapper mechanism 27.

Since this nozzle flapper mechanism 27 is disposed only at the end of the second passage 15, that is, at the outlet of the second chamber 9, the flapper 35 is opposed to just one nozzle 29. Accordingly, this can facilitate the positional adjustment of the flapper 35 relative to the nozzle 29, thus allowing accurate placement of the flapper unit 31 in a short time.

Furthermore, since the circuit configuration of the spool driving circuit 3 can be simplified, the machining costs of the valve main body can be reduced.

This allows the servo valve 1 to be manufactured at low cost.

Furthermore, since a bimorph piezoelectric element that has a relatively large deformation amount and that can be driven at a low voltage is used as the flapper 35, a small nozzle flapper mechanism 27 including a power supply can be constituted. Furthermore, the relatively low cost of the bimorph piezoelectric element can further reduce the manufacturing cost of the servo valve 1.

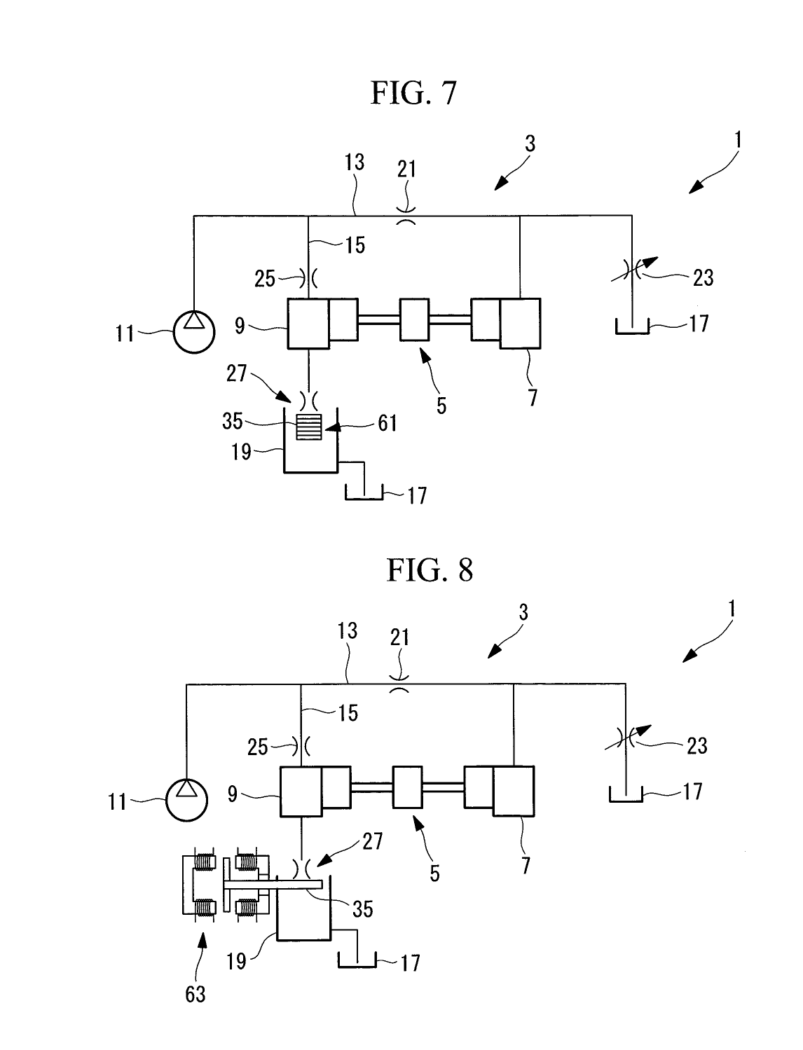

The flapper 35 of the nozzle flapper mechanism 27 may be driven by a layered piezoelectric element 61, as shown in FIG. 7.

Since the distance of the flapper 35 relative to one nozzle 29 is adjusted, only one layered piezoelectric element 61 is needed to move it.

This allows a smaller configuration as compared with a mechanism having the large layered piezoelectric elements 61 at both sides of the flapper 35, thus allowing the servo valve 1 to be made more compact.

Furthermore, this also allows the control of a control system for moving the flapper 35 to be simplified.

Thus, the practical servo valve 1 can be provided even with the layered piezoelectric element 61.

Furthermore, the flapper 35 of the nozzle flapper mechanism 27 may be driven by a torque motor 63 that performs linear motion, as shown in FIG. 8.

This allows the servo valve 1 capable of stable adjustment to be configured using the proven torque motor 63.

### Second Embodiment

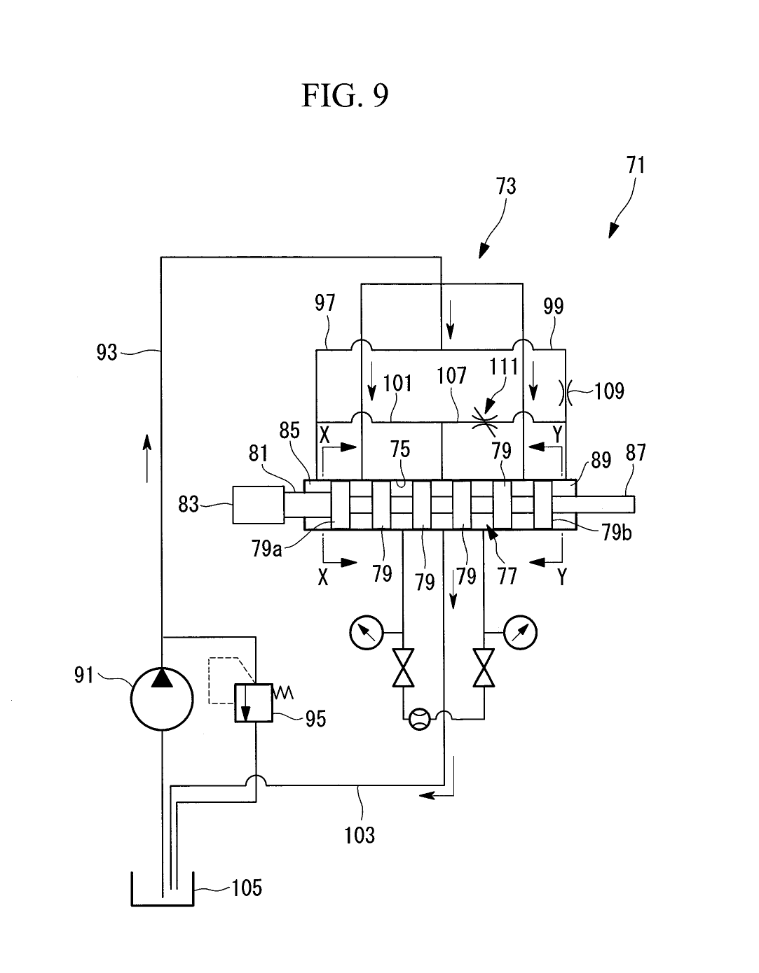

A servo valve 71 for controlling driving of a hydraulic actuator (not shown) according to a second embodiment of the present invention will be described hereinbelow using FIGS. 9 to 12.

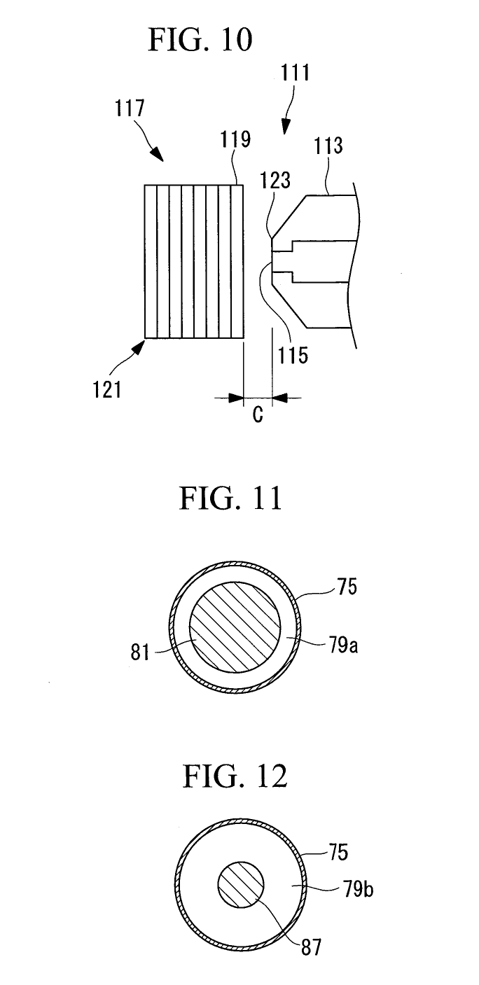

FIG. 9 is a circuit diagram illustrating a spool driving circuit (valve-element driving circuit) 73 of the servo valve 71. FIG. 10 is a partial sectional view illustrating part of a nozzle flapper mechanism. FIG. 11 is a cross-sectional view taken along line X-X in FIG. 9. FIG. 12 is a cross-sectional view taken along line Y-Y in FIG. 9.

The servo valve 71 is provided with a body 75 having a space inside and a spool (valve element) 77 disposed in the inner space of the body 75 so as to be movable in the axial direction.

The spool 77 is provided with a plurality of land portions 79 serving as sliding surfaces and having substantially the same diameter. The spool 77 moves in the axial direction so that the positions of these land portions 79 in the axial direction move. These land portions 79 have the function of switching a working-oil supply direction to the hydraulic actuator (not shown) depending on the positions in the axial direction.

A land portion 79a provided at one end of the spool 77 is provided with a first rod 81 projecting outward. The first rod 81 transmits its motion to a differential transformer 83. The differential transformer 83 detects the axial position of the spool 77.

A first chamber (first pushing portion) 85 is formed at the outer side of the land portion 79a so as to surround the first rod 81.

A land portion 79b provided at the other end of the spool 77 is provided with a second rod 87 projecting outward. A second chamber (second pushing portion) 89 is formed at the outer side of the land portion 79b so as to surround the second rod 87.

The spool driving circuit 73 is provided with a pump 91 that supplies oil through a main passage 93. The main passage 93 is provided with a pressure regulating valve 95, to which oil at a substantially constant pressure is supplied.

The main passage 93 is divided into a first passage 97 and a second passage 99. The oil that passes through the first passage 97 is supplied to the first chamber 85, passes through a pipe 101 and a return passage 103, and is returned to a tank 105. The first chamber 85 is directly supplied with the oil that is supplied through the main passage 93. The pressure of this supplied oil is the pressure Ps at which the pump 91 discharges.

The oil that passes through the second passage 99 is supplied to the second chamber 89, thereafter passes through a pipe 107 and the return passage 103, and is returned to the tank 105.

Since the first rod 81 passes through the first chamber 85, a first pressure-receiving area A1 where the land portion 79a receives pressure from the oil supplied to the first chamber 85 is of a size obtained by subtracting the cross-sectional area of the first rod 81 from the area of the land portion 79a, as shown in FIG. 11.

Since the second rod 87 passes through the second chamber 89, a second pressure-receiving area A2 where the land portion 79b receives pressure from the oil supplied to the second chamber 89 is of a size obtained by subtracting the cross-sectional area of the second rod 87 from the area of the land portion 79b, as shown in FIG. 12.

In this embodiment, the sizes of the first rod 81 and the second rod 87 are set so that the first pressure-receiving area A1 is substantially half of the second pressure-receiving area A2.

Note that the area ratio of the first pressure-receiving area A1 to the second pressure-receiving area A2 is not limited thereto.

The second passage 99 is provided with an inlet orifice 109 constituted by, for example, an orifice, upstream of the second chamber 89. The pipe 107 is provided with a nozzle flapper mechanism 111.

The nozzle flapper mechanism 111 is provided with a nozzle 113 mounted to the pipe 107 and a flapper unit 117 opposed to an opening 115 of the nozzle 113 and constituting a orifice.

The flapper unit 117 is provided with a flapper 119 and a layered piezoelectric element 121 in which a plurality of piezoelectric elements that drive the flapper 35 are layered.

The lateral area of a cylinder formed by the flapper 119 and the distal outer peripheral end 123 of the nozzle 113 determines the orifice level of the nozzle flapper mechanism 111.

A position at which the lateral area is equal to the opening area of the opening 115 (the state in FIG. 10) is a limit position at which the nozzle flapper mechanism 111 can offer the orifice function. That is, when the flapper 119 comes away the nozzle 113 relative to this position, the throttling effect becomes smaller than the throttling effect of the nozzle 113, and thus, the nozzle flapper mechanism 111 provides no orifice, function.

The flapper 119 is disposed at a midpoint position between this limit position and a position at which the flapper 119 and the nozzle 113 are in contact and, with the position as the center (origin), is configured to be displaced between the limit position and the position at which the flapper 119 and the nozzle 113 are in contact, that is, in an adjusting range C.

In this embodiment, the specifications of the nozzle flapper 111 are set so that when the flapper 119 is in the origin, the pressure P1 of oil in the first chamber 85 is substantially the same as the pressure Ps applied by the pump 91.

The operation of the thus-configured spool driving circuit 73 will be described.

When the pump 91 is driven, oil is supplied from the tank 105 through the main passage 93. The pressure Ps of the supplied oil is maintained substantially constant by the pressure regulating valve 95.

The oil flowing through the main passage 93 is divided and flows into the first passage 97 and the second passage 99.

The oil flowing into the first passage 97 flows into the first chamber 85 and is returned to the tank 105 through the pipe 101 and the return passage 103.

The oil flowing into the second passage 99 is reduced in pressure by the inlet orifice 109 and flows into the second chamber 89. The oil is discharged from the second chamber 89 to the pipe 107, passes through the nozzle flapper mechanism 111, and is returned to the tank 105 through the return passage 103.

At this time, if the flapper 119 is at the origin, the pressure P1 of the oil in the first chamber 85 is substantially the same as the pressure Ps supplied by the pump 91, that is, P1=Ps. A force (fluid pressure) F1 that the oil in the first chamber 85 exerts on the land portion 79a is expressed as F1=A1×Ps.

On the other hand, the pressure P2 of the oil in the second chamber 89 is substantially half of the pressure Ps supplied by the pump 91, that is, P2=Ps/2. A force (fluid pressure) F2 that the oil in the second chamber 89 exerts on the land portion 79b is expressed as F2=A2×Ps/2.

Since A2=2×A1, the force F2 is expressed as F2=2×A1×Ps/2=A1×Ps. Since the force F1 and the force F2 become equal, the differential pressure therebetween becomes 0. In the state of the differential pressure of 0, the spool 7 is in a halted state.

When a voltage is applied to the layered piezoelectric element 121 to displace the flapper 119 to the nozzle 113 side, the lateral area of the cylinder formed by the flapper 119 and the distal outer peripheral end 123 of the nozzle 113, that is, the orifice level of the nozzle flapper mechanism 111, becomes lower than that at the origin.

When the orifice level of the nozzle flapper mechanism 111 becomes low, the throttling effect of the nozzle flapper mechanism 111 increases, so that the pressure P2 of the oil in the second chamber 89 becomes higher than Ps/2.

When the pressure P2 becomes high, a force F2 that the oil in the second chamber 89 exerts on the land portion 79b becomes large, so that the force F2 becomes larger than the constant force F1 in the first chamber 85.

This differential pressure causes the spool 77 to move to the first chamber 85 side.

When an opposite voltage is applied to the layered piezoelectric element 121 to displace the flapper 119 at the origin in the direction away from the nozzle 113, the lateral area of the cylinder formed by the flapper 119 and the distal outer peripheral end 123 of the nozzle 113, that is, the orifice level of the nozzle flapper mechanism 111, becomes larger than that when at the origin.

When the orifice level of the nozzle flapper mechanism 111 becomes high, the throttling effect of the nozzle flapper mechanism 111 decreases, so that the pressure P2 of the oil in the second chamber 89 becomes lower than Ps/2.

When the pressure P2 becomes low, the force F2 that the oil in the second chamber 89 exerts on the land portion 79b becomes small, so that the force F2 becomes smaller than the constant force F1 in the first chamber 85.

This differential pressure causes the spool 77 to move to the second chamber 89 side.

Thus, since the pressure of oil supplied to the first chamber 85, that is, the force F1 that acts on the land portion 79a, is maintained at a substantially constant level, the spool 77 moves back and forth by adjusting the pressure of the oil in the second chamber 89 using the nozzle flapper mechanism 111.

Since this nozzle flapper mechanism 111 is disposed only at the pipe 107, that is, at the outlet of the second chamber 89, the flapper 119 is opposed to just one nozzle 113.

Accordingly, this can facilitate the positional adjustment of the flapper 119 relative to the nozzle 113, thus allowing accurate placement of the flapper unit 117 in a short time.

Furthermore, since the circuit configuration of the spool driving circuit 73 can be simplified, the machining costs of the valve main body can be reduced.

This allows the servo valve 71 to be manufactured at low cost.

Since the oil supplied from the pump 91 to the first chamber 85 is supplied directly, in other words, the first orifice 21 and the pressure regulating orifice 23 of the first embodiment are omitted, the circuit configuration of the valve-element driving circuit 73 can be further simplified. Since this eliminates adjustment of the pressure regulating orifice 23 etc. adjustment costs can be reduced.

This can reduce further the machining costs of the servo valve 71 main body, thus allowing the servo valve 71 to be manufactured at lower cost.

When the first orifice 21 and the pressure regulating orifice 23 are used as in the first embodiment, the space from the first orifice 21 to the pressure regulating orifice 23 including the first chamber 85 constitutes a large voluminous chamber because of separation by the first orifice 21 and the pressure regulating orifice 23. This increases the spring constant of the oil in this space, thus easily causing resonance. Since this embodiment does not use the first orifice 21 and the pressure regulating orifice 23, resonance can be avoided, and thus the accuracy when driving at a high frequency can be improved.

In this embodiment, although the flapper 119 of the nozzle flapper mechanism 111 is driven by the layered piezoelectric element 121, it is not limited thereto.

For example, the bimorph piezoelectric element that can be driven at a low voltage, used in the first embodiment, may be used. This allows a small nozzle flapper mechanism 111 including a power supply to be constituted. The relatively low cost of the bimorph piezoelectric element can further reduce the manufacturing cost of the servo valve 71.

For example, a torque motor that performs linear motion may be used for driving.

This allows the servo valve 71 capable of stable adjustment to be configured using a proven torque motor.

In this embodiment, the first pressure-receiving area A1 and the second pressure-receiving area A2 are adjusted depending on the sizes of the respective cross-sectional areas of the first rod 81 and the second rod 87; however, it is not limited thereto.

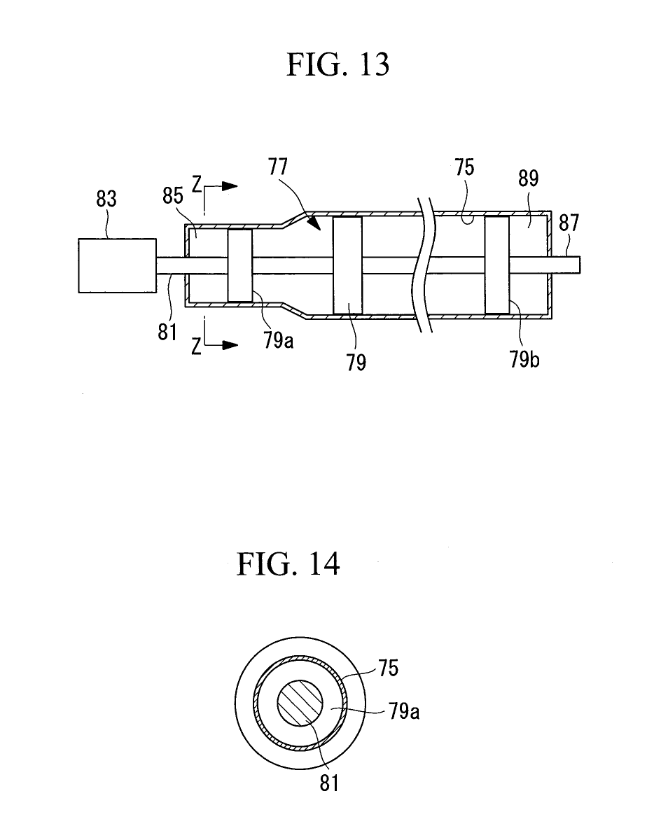

For example, as shown in FIGS. 13 and 14, it is also possible to adjust the areas of the land portion 79a and the land portion 79b, with the cross-sectional areas of the first rod 81 and the second rod 87 set equal.

In this embodiment, the first pressure-receiving area A1 is set to substantially half of the second pressure-receiving area A2; however, the ratio of the first pressure-receiving area A1 to the second pressure-receiving area A2 is not limited thereto.

That is, the oil pressures in the first and second chambers 85 and 89 and the sizes of the first pressure-receiving area A1 and the second pressure-receiving area A2 should be selected so that the pressure of the oil in the first chamber 85 comes to a level obtained by multiplying the pressure of the oil in the second chamber 89 when the flapper 119 is located at the origin by A2/A1.

The present invention is not limited to the embodiments described above, and various modifications may be made without departing from the spirit of the present invention.

### Reference Signs List

1 Servo Valve

3 Spool Driving Circuit

5 Spool

7 First Chamber

9 Second Chamber

35 Flapper

61 Layered Piezoelectric Element

63 Torque Motor

71 Servo Valve

73 Spool Driving Circuit

77 Spool

85 First Chamber

89 Second Chamber

119 Flapper

121 Layered Piezoelectric Element

1. A servo valve including a valve element mounted so as to be movable back and forth; a first pushing portion and a second pushing portion that mutually push the valve element in opposite directions by means of fluid pressure; and a valve-element driving circuit that supplies fluid to the first pushing portion and the second pushing portion and that adjusts the pressure of the supplied fluid to move the valve element back and forth,
wherein the valve-element driving circuit maintains the fluid pressure of the first pushing portion at a substantially constant level and includes a nozzle flapper mechanism, at a fluid outlet of the second pushing portion, that adjusts the fluid pressure of the second pushing portion.

2. The servo valve according to claim 1, wherein, in the valve element, a first pressure-receiving area where the fluid in the first pushing portion acts on the valve element and a second pressure-receiving area where the fluid in the second pushing portion acts on the valve element are set to substantially the same area.

3. The servo valve according to claim 1, wherein, in the valve element, a first pressure-receiving area where the fluid in the first pushing portion acts on the valve element and a second pressure-receiving area where the fluid in the second pushing portion acts on the valve element are set to substantially different areas.

4. The servo valve according to claim 1, wherein a flapper of the nozzle flapper mechanism is driven by a bimorph piezoelectric element.

5. The servo valve according to claim 1, wherein a flapper of the nozzle flapper mechanism is driven by a layered piezoelectric element.

6. The servo valve according to claim 1, wherein a flapper of the nozzle flapper mechanism is driven by a torque motor.
